(19) United States
(12) Patent Application Publication
(10) Pub. No.: US 2008/0117791 A1
(43) Pub. Date: May 22, 2008

(54) OPTICAL MEDIA IDENTIFICATIONS

(75) Inventors: Qin Heng Wang, Shanghai (CN); Lei Shi, Shanghai (CN); Xiao Hui Cao, Shanghai (CN); Qi Xin, Shanghai (CN)

Correspondence Address: FISH & RICHARDSON P.C., PO BOX 1022, MINNEAPOLIS, MN, 55440-1022, US

(73) Assignee: ATMEL CORPORATION, San Jose, CA (US)

(21) Appl. No.: 11/561,867

(22) Filed: Nov. 20, 2006

(51) Int. Cl. G11B 7/24

(52) U.S. Cl. 369/275.3; 369/272.1

(57) ABSTRACT

Methods, systems, and apparatus, including computer program products for identifying optical disc media. In one aspect a method is provided that includes receiving printed information read from an optical media disc. Identifying a media-type of the optical media disc from the printed information. The printed information can be printed on optical media disc in ink. The printed information can be printed on optical media disc which includes a plurality of stripes. The printed information can be read from a burst-cutting area on the media disc

### BACKGROUND

The present disclosure relates to media identification.

The media format of an optical disc includes information describing the physical and logical layout of the data encoded on the disc. Currently, there are a variety of optical media formats currently in wide spread use. Despite their similar physical appearance a conventional media disc could have one of the following media formats: compact disc (CD), digital video disc (DVD) also known as digital versatile disc, high-definition DVD (HDDVD), Blue-ray (BD) or one of many other potential formats. Each of these general media formats can have a variety of sub-formats (e.g., DVD−ROM, DVD−R, DVD−RW, DVD+R, DVD+RW). Optical media can also include multiple storage layers. Typically, each media format must be read in a manner that corresponds to the particular media format, otherwise data cannot be properly read from the disc. Users of optical media discs expect/hope conventional optical media players will recognize and properly play, or read data from, any optical media regardless of the disc's particular media format.

For optical media players to properly play optical media the player must distinguish the format of the optical media. Typically, distinguishing between CD and DVD discs is determined by moving the player's optical lens to focus and refocus the lens. Information is read from the disc during the refocusing procedure to estimate the physical distance from plastic layer of the disc to the reflective disc layer because the distance typically differs among CD and DVD discs. To distinguish between sub-formats such as DVD+R/RW and DVD−R/RW the player rotates the disc at a fixed speed and can then detect the disc's wobble clock frequency which differs between the sub-formats. Another method used to identify disc formats includes detecting a disc's reflection signal amplitude, however this method will fail if the disc has not been fabricated in strict compliance with the disc's respective media format specification. Yet, another method includes attempting to read the lead-in area of a disc, at multiple possible positions specified by multiple respective supported formats. These methods are often time consuming and, in some cases, can fail completely to identify the media format of the disc.

The burst cutting area (BCA) is a feature of the DVD physical specification that specifies an area on the disc where data can be encoded onto the disc using, for example, a powerful laser (e.g., a CO2 or YAG (yttrium aluminum garnet) laser). The encoded information typically includes an identifier to uniquely identify each disc. The identifier can be used to generate or specify decryption keys necessary to decrypt encrypted data on the rest of the disc. Generally, however the BCA is often unused by DVD manufacturers as many DVD players do not read the BCA. Other optical media formats that have emerged since DVD (e.g., DVD−RAM, HDDVD and BD) also specify a BCA area, however the encoding format of the BCA differs among media formats. In particular, the data map and synchronization pattern specified for reading data from the BCA differ among the other media formats.

### SUMMARY

This specification describes method, apparatus, systems and computer program products for identifying optical disc media. Information including an optical disc's format, sub-format and layer count can be encoded as a machine readable code and printed on the disc.

In general, one aspect of the subject matter described in this specification can be embodied in methods that include receiving printed information read from an optical media disc. Identifying a media-type of the optical media disc from the printed information. Other embodiments of this aspect include corresponding systems, apparatus, and computer program products.

These and other embodiments can optionally include one or more of the following features. The printed information can be printed on optical media disc in ink. The printed information can be printed on optical media disc which includes a plurality of stripes. The printed information can be read from a burst-cutting area on the media disc. The printed information can be read using a pick-up head. The pick-up-head can be adjusted to read data from the optical media disc based on the media-type of the optical media disc. Data can be read from the optical disc based on the identified media-type. Identifying a media-type of the optical media disc can include decoding information based on a disc identification code structure. The disc identification code structure can include information identifying a media format, a number of media layers and a media-sub-format. The media format can include one of: CD, DVD, HDDVD or BD. The disc identification code structures can include parity information.

In general, another aspect of the subject matter described in this specification can be embodied in methods that include receiving a media-type for an optical media disc. Information encoding the media-type is printed onto the optical media disc. Other embodiments of this aspect include corresponding systems, apparatus, and computer program products.

These and other embodiments can optionally include one or more of the following features. The information can be printed in an area incident with a burst-cutting area. Printing information can include printing a series of stripes encoding the media-type. Printing the media-type information can include printing information based on a disc identification code structure. The disc identification code structure can include information about: media format, media layers and media sub-format. Media format can include one of: CD, DVD, HDDVD or BD.

In general, another aspect of the subject matter described in this specification can be embodied in an optical media including a printed code that identifies the media type of the optical media.

These and other embodiments can optionally include one or more of the following features. The printed code is printed in ink. The ink is low-reflectance ink. The printed code is a series of stripes encoding the media-type.

Particular embodiments of the subject matter described in this specification can be implemented to realize one or more of the following advantages. The format of an optical disc media can be determined much more quickly and accurately than conventional media detection techniques. Media format information can be printed easily and economically on optical disc media using ink; without using laser etching. The media format information can be read by widely used and existing optical pickup readers. The technique of printing identification information on the disc is backward compatible in that the function of the disc is maintained when used in conventional optical disc reading systems. The technique of reading identification is backward compatible in that, if a disc does not have identifying information, the disc's media format can be determined conventionally.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is an illustration of an exemplary media disc.

FIG. 2 is an illustration of an exemplary readout signal.

FIG. 3 is an illustration of a disc identification information data frame.

FIG. 4 is an illustration of a system for decoding media format information.

FIG. 5 is a flow diagram of a process for reading media format information.

FIG. 6 is a flow diagram of a process for printing media format information on a disc.

Like reference symbols in the various drawings indicate like elements.

### DETAILED DESCRIPTION

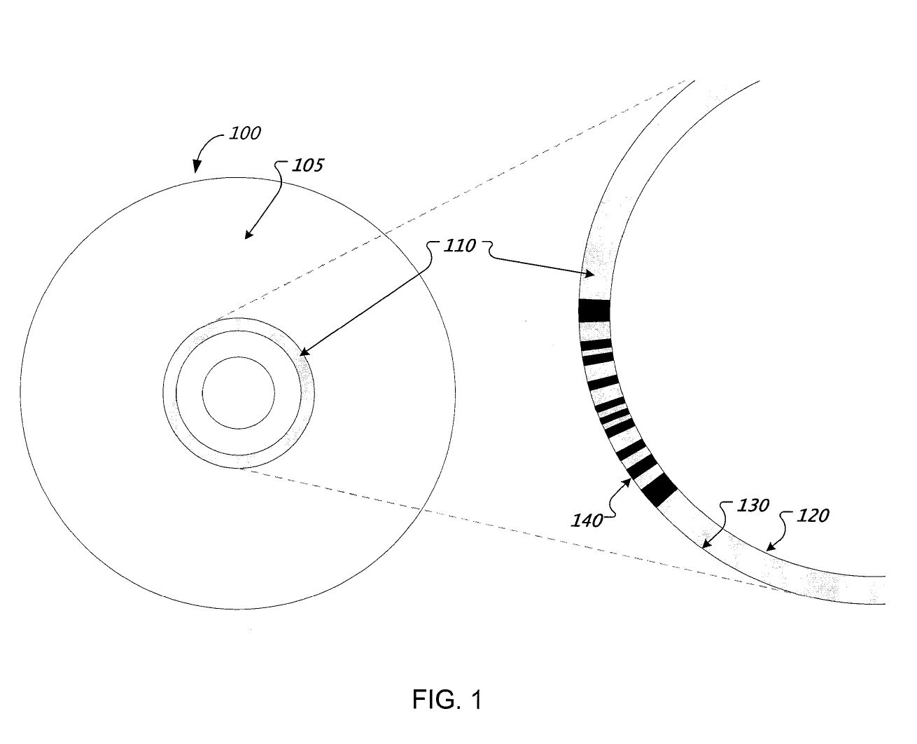

FIG. 1 is an illustration of an exemplary media disc 100 that can be in one of many potential media formats (e.g., CD, DVD, HDDVD, BD, etc.). The media format of the disc 100 specifies the particular physical and logical arrangement of the data stored or recorded on some portion 105 of the disc. The data on the disc can include encoded music, video, text, other digital information or a combination thereof.

A media disc, regardless of the disc's particular media format, can include a format identification area 110 (FIA), which is illustrated as a concentric ring. The FIA 110 can be inside the data portion 105 of the disc on the same side of the disc as the encoded data. In some implementations, the FIA 110 is present on both sides of a dual-sided disc (e.g., where both sides of the disc store data). The FIA 110 can be specified according to an inner 120 and outer 130 diameters. In some implementations, the FIA 110 and the area's inner 120 and outer 130 diameters are coincident with the burst-cutting area of a media disc (e.g., as specified in Annex K of the DVD standard). Information is encoded and printed into the inner area as, for example, a series of stripes 140. The stripes can be printed within the area so that each stripe extends radially between the inner 120 and outer 130 diameters of the FIA 110. In one implementation, the stripes can be printed or applied directly to the surface or a subsurface of the disc. The stripes can, for example, be printed with permanent, low-reflectance ink (e.g., black in color). In one implementation, the ink is applied to the disc to prevent the ink from peeling or lifting from the disc's surface.

The stripes printed in the FIA 110 can be used to encode information identifying the media format of the disc 100. For example, stripes can be printed in a manner consistent with a machine readable code (e.g., a bar code) to facilitate reading and decoding of the information encoded by the stripes.

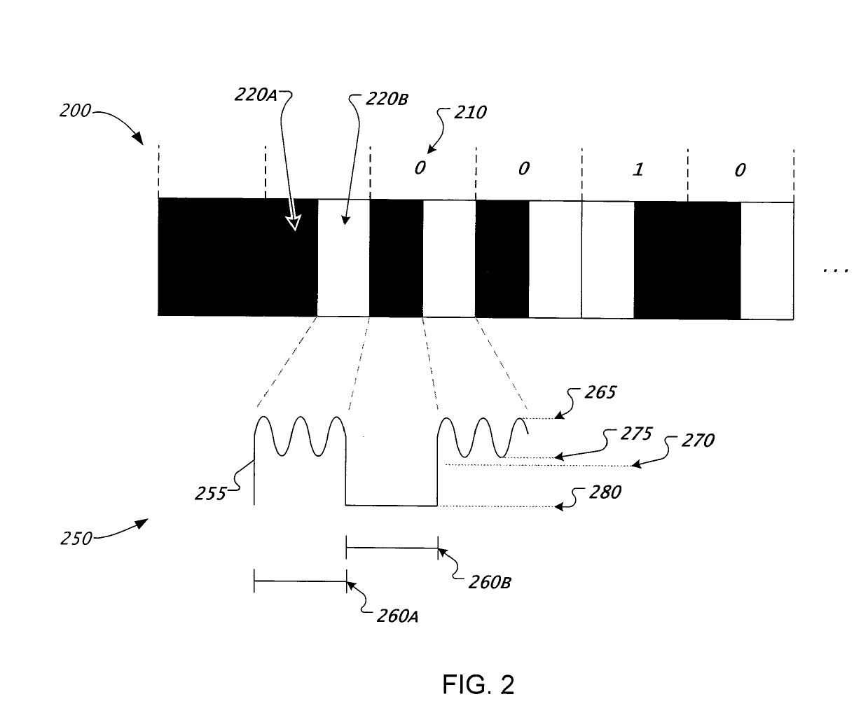

FIG. 2 is an illustration 250 of an exemplary readout signal 255. The readout signal 255 can be generated from reading the FIA of the media disc. The exemplary readout signal 255 corresponds to exemplary format identification information 200, encoded by stripes printed in the FIA. Each black stripe corresponds, in some implementations, to an area covered by low-reflectance ink. The area between stripes (illustrated in white) can corresponds to an absence of a stripe or a ‘gap’. In some implementations, a gap between stripes is simply an area of a disc not covered by low-reflectance ink, thus revealing the reflective layer of an optical disc. In other implementations, a gap can be an area covered by high-reflectance ink.

The area of the disc over which the encoded information is printed can be logically partitioned into cells 220 called channel bits. The physical width of each channel bit can be approximately equidistant. In some implementations, the mean physical width of each channel bit is 0.6 millimeters. Thus, each channel bit corresponds either to a stripe 220A (e.g., a low-reflectance stripe) or a gap 220B. In some implementations, wherein the disc is assumed to have a rotational speed of substantially 1440 revolutions per minute (24 Hz), the width of a channel bit, expressed in microseconds, is substantially 86.85 μs. In some implementations, the maximum deviation of a channel bit (e.g., the center of a stripe to the center of the gap or stripe in the next cell) is less than 8.68 μs.

The readout signal 255 can be generated by an optical sensor, which in some implementations, can be included in an optical pick up head. The optical sensor produces a readout signal in response to reading the stripes printed in the FIA. A ‘high’ signal 260A may range between a peak amplitude 265 and a lesser amplitude 275. The potential variance of amplitude between the peak 265 and lesser 275 amplitudes can correspond to noise detected while reading the printed disc identification encoding (e.g., while reading a gap). A ‘low’ signal 260B has an amplitude 280, which is strictly less than either the amplitude 265 or 275. In some implementations, the low signal 260B generated is in response to reading a stripe (e.g., a low-reflectance stripe) while the high signal 260A is generated in response to reading areas on the disc that are not covered by a stripe. An edge position of the signal 255 refers to when the signal transitions between ‘high’ and ‘low', characterized by the signal's amplitude crossing a mean level 270 between the peak signal amplitude 265 and the low signal amplitude 280.

A pair of channel bits (e.g., 220A and 220B) can encode a value of a single data bit (e.g., the value 210). In one implementation, the width of each encoded data bit is the width of two channel bits. In some implementations the width of the encoded data bit, expressed in microseconds, is substantially 173.7 μs. In one implementation, a data bit is encoded over a pair of channel bits in the following phase-encoded fashion:

| 1^{st} channel bit | 2^{nd} channel bit | Data bit value |
|---|---|---|
| Low (0) | High (1) | 0 |
| High (1) | Low (0) | 1 |

In one implementation, a sequence of channel bits can be modulated based on return-to-zero modulation. The stripes can be printed to correspond to pulses after the return-to-zero modulation.

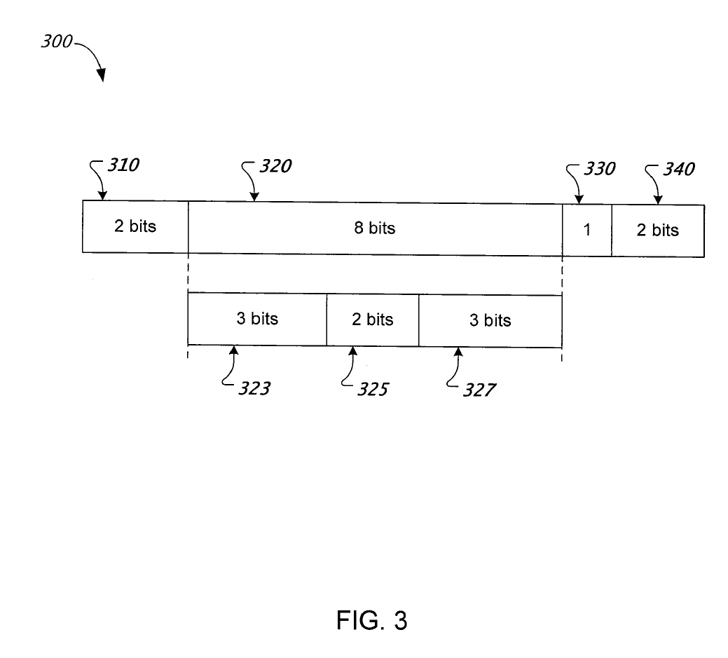

FIG. 3 is an illustration of a disc identification information data frame 300. The data frame 300 includes a start flag 310. The start flag can be printed on a media disc as a stripe that covers an area equivalent to the length of, for example, two channel bits. Similarly, the data frame 300 also includes an end flag 340. The end flag, like the start flag, can be printed on a media disc as a stripe covering, for example, two channel bits. In between the start flag 310 and the end flag 340, the data frame 300 includes a data payload 320 and parity information 330. The data payload 320 includes all the bits necessary to encode media format information about a disc. The parity information 330 can be used to verify that information from the data payload 320 is correctly read. For example, in some implementations the parity information 330 is a single bit which is the result of an XOR bit operation on the data bits in the data payload 320. In other implementations, parity information 330 can include information to correct errors in the information read from the data payload 320 (e.g., error-correcting codes).

In one implementation, the data payload 320 can include information that pertains to three categories of disc media format information including: media format 323, media layers 325 and media sub-formats 327. In some implementations the data payload 320 can include additional categories of disc media format information.

Media format 323 data encodes information identifying one of several potential media disc types including: CD, DVD, HD−DVD, and BlueRay. Other media disc types are also possible, for example, the media format information can identify whether the disc is HVD (holographic versatile disc), DMD (digital multilayer disk), UMD (universal media disc), or a hybrid type (e.g., DVD Plus, HD−DVD/BluRay, etc.).

Media layer 325 data encodes information about the number of layers in the media disc. For example, the media layer information can identify whether the disc is single layer or dual layer. In some implementations, media layer information can also include information about whether a layer includes an alternate media format layer (e.g., a DVD layer on a BluRay disc).

Media sub-format 327 data encodes information related to the particular subtype of a media disc format. Media format sub-type can include information such as whether the disc is read-only or writable (e.g., writable once) or rewritable (e.g., writable more than once). In some implementations, media format sub-type includes information that distinguishes a sub-format of the disc's media format (e.g., the DVD+R and DVD−R sub-formats).

In some implementations, the data payload 320 can include eight bits of information that are used to encode media format (three bits), media layers (two bits) and media sub-format (three bits). The data payload 320 can be encoded using the data table below. The table includes a column for each category of disc media format information. Each column includes a value that can be encoded into the data payload 320 and the value's meaning.

| | Media Format | | Layers | | Sub-Format |
|---|---|---|---|---|---|
| 000 | CD | 00 | 1 layer | 000 | CD−ROM |
| | | 01 | 2 layer | 001 | CD−R |
| | | xx | Reserved | 010 | CD−RW |
| | | | | xxx | |
| 001 | DVD | 00 | 1 layer | 000 | DVD−ROM |
| | | 01 | 2 layer | 001 | DVD−R |
| | | xx | Reserved | 010 | DVD−RW |
| | | | | 011 | DVD+R |
| | | | | 100 | DVD+RW |
| | | | | 101 | DVD−RAM |
| | | | | xxx | reserved |
| 010 | HD−DVD | 00 | 1 layer | 000 | HDDVD−ROM |
| | | 01 | 2 layer | 001 | HDDVD−R |
| | | 11 | twin layer | 010 | HDDVD−RAM |
| | | xx | reserved | 011 | HDDVD−RW |
| | | | | xxx | reserved |
| 011 | Blue−Ray | 00 | 1 layer | 000 | BD−ROM |
| | | 01 | 2 layer | 001 | BD−R |
| | | xx | reserved | 010 | BD−RE |
| | | | | xxx | reserved |
| xxx | reserved | | | | |

For example, a twin layer HD−DVD−RW disc can be encoded in the following eight bit value: 01011011. Among implementations where the data payload includes 8 bits of information, the entire data frame can be printed over a substantially 10.8 mm length of the FIA (e.g., 0.6 mm by two channel bits by nine data bits).

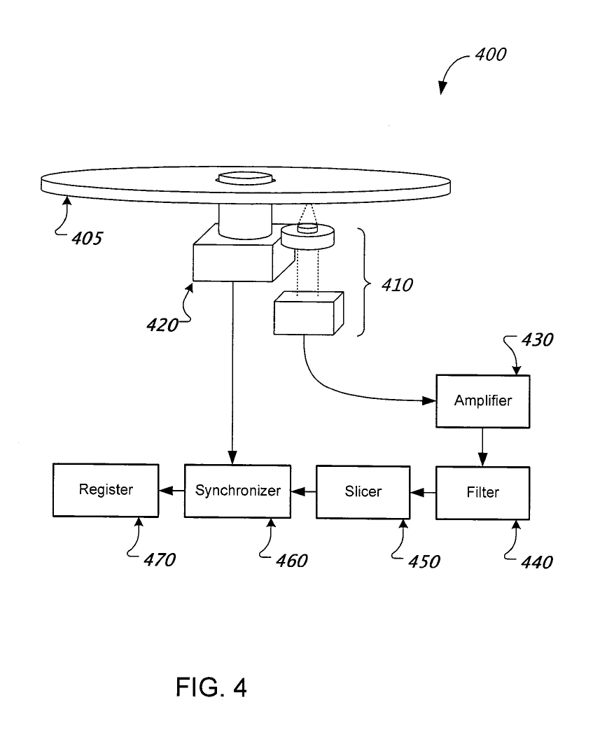

FIG. 4 is an illustration of a system 400 including a circuit diagram for detecting and decoding the media format information printed in the FIA of a media disc 405. The media disc 405 can be attached or mounted to a rotor that is turned by a motor 420. The system 400 includes an optical sensor 410. The optical sensor can also include a pick-up head, tracking mechanism and focus coils (e.g., to control the position of the optical sensor with respect to the mounted disc 405). The optical sensor (e.g., a laser lens) 410 can be used to read information encoded on a disc 405. In some implementations, the optical sensor 410 used to read the main data from the disc is the same optical sensor 410 used to read stripes printed in the disc that encode disc media format information.

The system 400 can include an amplifier 430. The signal produced by the optical sensor 410 can be received and amplified by the amplifier 430. The system 400 can include a filter 440 (e.g., a low-pass filter). The amplified signal can be received by filter 440 which can remove noise (e.g., high frequency noise) from the signal. The system 400 can include a slicer 450 (e.g., an analog to digital conversion circuit). The signal can be received by the slicer 450, to convert the analog signal received from the optical sensor 410 into a digital signal. The system 400 can also include a synchronizer 460. The synchronizer 460 can be used to synchronize the signal being received from the optical head 410 with respect to the rotation of the disc 405. In some implementations the synchronizer 460 can be a clock corresponding to the rotational speed of the motor 420. In other implementations a signal from the motor can be received and used to synchronize the signal. The synchronizer 460 can be used to determine when the signal from the optical sensor 410 is sampled. For example, based on detection of the printed start flag and the rotational speed of the disc, a signal from the optical sensor 410 can be read at specific intervals corresponding to the middle of each channel bit (e.g., the middle of a stripe).

The system 400 is an exemplary system. Any one of the illustrated components can be combined. In some implementations, the functionality of a single component can be achieved using multiple separate components.

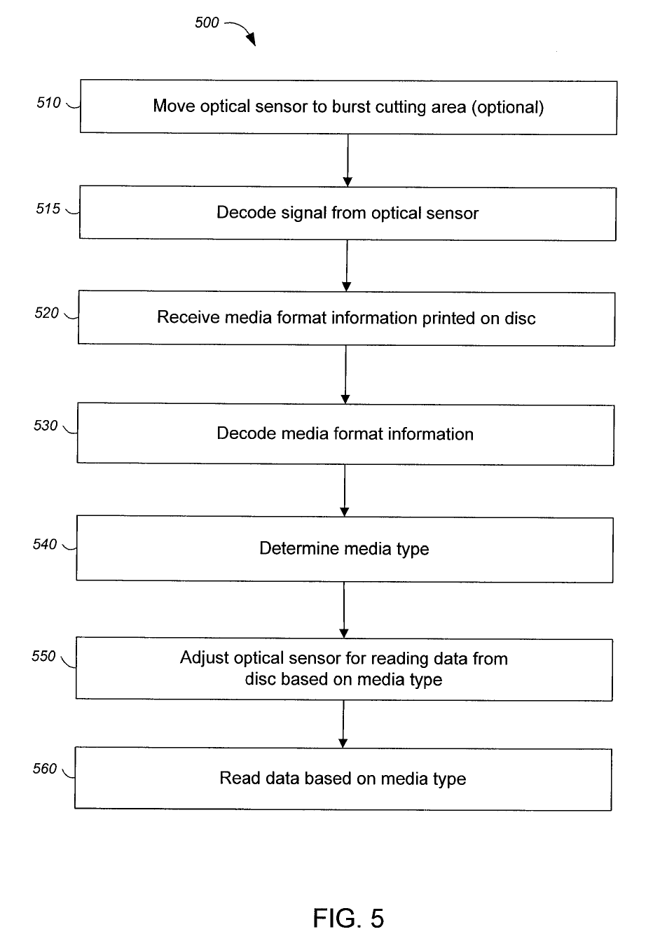

FIG. 5 is a flow diagram of a process 500 for reading media format information from an optical disc. The process 500 can include moving a pick-up head, including the head's optical sensor, to a radius that corresponds to the FIA of the disc (step 510). In some implementations however, the pick-up head can be automatically positioned or can be positioned by another process. The process 500 can include decoding a signal from the optical sensor into digital media format information (step 515). The process 500 includes receiving media format information based on the information printed on the FIA area of the disc (step 520). Media format information can be decoded according to the data frame and values used to encode media format information (step 530). For example, the first three bits of the media format information can be decoded such that value ‘001’ is determined to correspond to DVD media. In some implementations, decoding media format information can include using parity information encoded with the media format information. For example, if the parity information is incorrect the media format information can be re-read from the disc. In other implementations, the parity information may be used to reconstruct missing or erroneous media format information data (e.g., if parity information includes error-correcting codes).

The process 500 can include determining the media type from the decoded media format information (step 540). In some implementations, each readable or supported media type can be associated with media format specification information. Format specification information can be used to determine how data from the disc of a particular media type can be read. The process 500 includes adjusting the optical sensor for reading data from the media disc based on the media type (step 550). Primary data from the disc can be read using the adjusted optical sensor (e.g., based on the media-type determined in step 540) (step 560). In some implementations, if media format information cannot be read (e.g., when the disc is not printed with media format information) or cannot be determined (e.g., when the printed media format information is corrupted), then the media type can be determined based on a fall-back media type detection approach. Fall-back media detection can vary among implementations and typically can include refocusing and repositioning the optical sensor to detect layer information and the physical properties of the disc.

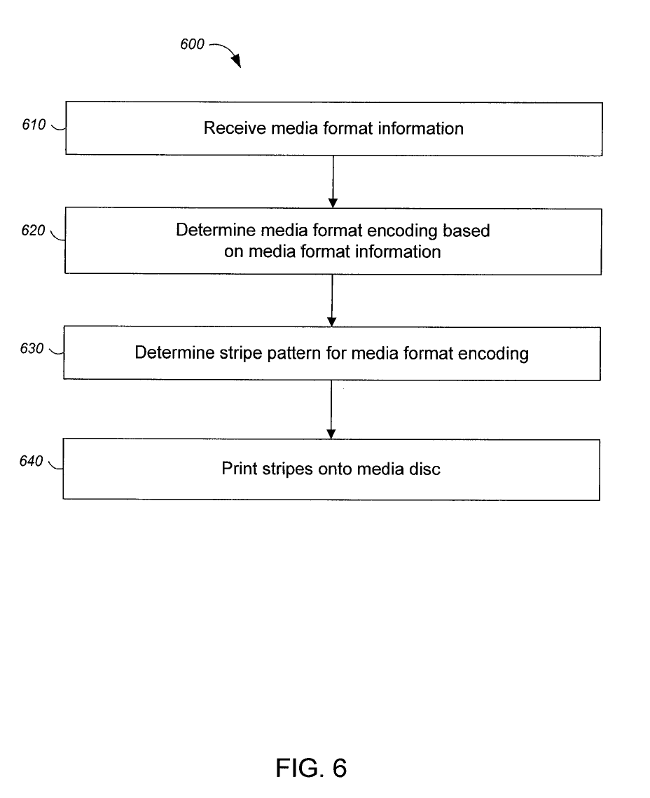

FIG. 6 is a flow diagram for a process 600 for printing media format information on a disc. The process 600 includes receiving media format information (step 610). For example, the received media format can specify for a particular disc: the media format, layers, sub-format, etc. The process 600 includes optionally determining an encoded media format information (e.g., a sequence of binary values) based on the received media format (step 620). Encoding can be optional. For example, a twin layer HD−DVD−RW disc can be encoded in the following eight bit value: 01011011. The process 600 includes determining a stripe pattern for the media format encoding (step 630). For example, the stripe pattern specifies the location and size of each stripe to be printed on the disc. The process 600 can include printing stripes that encode the media formation information about a media disc on the media disc (step 640).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system.

A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CT)-ROM and DVD−ROM disks. The processor and the memory can be supplemented by, or incorporated in, special purpose logic circuitry.

While this specification contains many specifics, these should not be construed as limitations on the scope of the invention or of what can be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method comprising:
receiving printed information read from an optical media disc; and
identifying a media-type of the optical media disc from the printed information.

2. The method of claim 1, where:
the printed information is printed on optical media disc in ink.

3. The method of claim 1, where:
the printed information is printed on optical media disc which includes a plurality of stripes.

4. The method of claim 1 further comprising:
reading the printed information from a burst-cutting area on the media disc.

5. The method of claim 1, further comprising:
reading the printed information using a pick-up head and adjusting the pick-up-head to read data from the optical media disc based on the media-type of the optical media disc.

6. The method of claim 1, further comprising:
reading data from the optical media disc based on the identified media-type.

7. The method of claim 1, where identifying a media-type of the optical media disc includes:
decoding information based on a disc identification code structure.

8. The method of claim 1, where the disc identification code structure includes:
information identifying a media format, a number of media layers and a media-sub-format.

9. The method of claim 8, where:
the media format can include one of: CD, DVD, HDDVD or BD.

10. The method of claim 8, where disc identification code structures includes:
parity information.

11. A method comprising:
receiving a media-type for an optical media disc; and
printing information encoding the media-type onto the optical media disc.

12. The method of claim 11, where:
the information is printed in an area incident with a burst-cutting area.

13. The method of claim 11, where printing information includes:
printing a series of stripes encoding the media-type.

14. The method of claim 11, where printing the media-type information includes:
printing information based on a disc identification code structure.

15. The method of claim 14 where:
the disc identification code structure includes information about: media format, media layers and media sub-format.

16. The method of claim 15, where:
media format includes one of: CD, DVD, HDDVD or BD.

17. An optical media including:
a printed code identifying the media type of the optical media.

18. The media of claim 17 where:
the printed code is printed in ink.

19. The media of claim 18, where:
the ink is low-reflectance ink.

20. The media of claim 17 where:
the printed code is a series of stripes encoding the media-type.

21. A computer program product, encoded on a computer-readable medium, operable to cause data processing apparatus to perform operations comprising:
receiving printed information read from an optical media disc; and
identifying a media-type of the optical media disc from the printed information.

22. A computer program product, encoded on a computer-readable medium, operable to cause data processing apparatus to perform operations comprising:
receiving a media-type for an optical media disc; and
printing information encoding the media-type onto the optical media disc.

23. A system comprising:
receiving printed information read from an optical media disc; and
identifying a media-type of the optical media disc from the printed information.

24. A system comprising:
receiving a media-type for an optical media disc; and
printing information encoding the media-type onto the optical media disc.
